(19) United States
(12) Patent Application Publication
(10) Pub. No.: US 2018/0051963 A1
(43) Pub. Date: Feb. 22, 2018

(54) Personal Safety Device

(71) Applicant: Jim KUSHNERYK, Hinton (CA)

(72) Inventor: Jim KUSHNERYK, Hinton (CA)

(21) Appl. No.: 15/240,968

(22) Filed: Aug. 18, 2016

(51) Int. Cl. F41H 9/10; B65D 83/20; B65D 83/38; B65D 83/22; G08B 3/00; G08B 15/02

(52) U.S. Cl. CPC F41H 9/10; B65D 83/20; G08B 15/02; B65D 83/22; G08B 3/00; B65D 83/388

(57) ABSTRACT

A reusable personal safety device for use with a prior art spray repellant canister having a cap, the device having a housing with an alarm component forming the top of the housing, a battery component extending perpendicularly downward from a first end of the alarm component, a support bracket extending perpendicularly downward from a second end of the alarm component, and canister securing means.

### FIELD OF THE INVENTION

The present invention relates to safety tools. In particular, the present invention relates to an improved repellant spray device.

### BACKGROUND OF THE INVENTION

It is known in the prior art to provide various devices which are designed to deter large animals or others who threaten to attack an individual. One common prior art device is a bear spray can containing a spray repellant offensive to bears. Other repellant sprays include mace for use against human attackers, dog repellant sprays, and others. All such sprays are referred to herein as “repellant sprays”.

Some prior art approaches include devices for adding alarms to repellant spray devices, and devices added to repellant spray to send wireless alarms to mobile devices.

While there is prior art which incorporates an alarm which is triggered during spraying of the repellant, the device taught in U.S. Pat. No. 5,644,297 is a complex purpose-built canister assembly which does not make use of existing standard repellant spray widely available.

Still other prior art incorporates an alarm with a repellant spray canister, but the alarm in U.S. Pat. No. 5,374,919 is activated by the action of removing the repellant spray from the containment device, whether or not the repellant spray is immediately used.

None of the prior art provides, in one lightweight, low cost device, a housing for use with a commonly available repellant spray canister, which incorporates an alarm activated only upon expelling the bear spray repellant, and which includes means for avoiding unintentional use while providing selectivity between spray and/or alarm options.

As will be described below, the personal safety device of the present invention provides all of these features.

### BRIEF DESCRIPTION OF THE DRAWINGS

A detailed description of the preferred embodiments is provided by way of example only and with reference to the following drawings, in which:

FIG. 1 is a front plan view of one embodiment of the invention;

FIG. 2 is a front plan view of a second embodiment of the invention;

FIG. 3 is a front plan view of the first embodiment of the invention attached to a bear spray canister; and

FIG. 4 is a side plan view of the first embodiment of the invention attached to a bear spray canister.

In the drawings, one embodiment of the invention is illustrated by way of example. It is to be expressly understood that the description and drawings are only for the purpose of illustration and as an aid to understanding, and are not intended as a definition of the limits of the invention.

### SUMMARY OF THE INVENTION

According to one of its aspects, there is provided a reusable personal safety device for use with a spray repellant canister having a trigger lock, the device having a housing with an alarm component with first and second ends, a battery component, a support bracket, and canister securing means.

The alarm component may form the top of the housing, and may have an alarm capacity of at least 130 Decibels.

The battery component may extend perpendicularly downward from the first end of the alarm component. The support bracket may extend perpendicularly downward from the second end of the alarm component. The distance between the inner side of the battery component and the inner side of the support bracket may be minimally larger than the diameter of a prior art repellant spray canister.

According to another aspect, the invention is a reusable personal safety device for use with a spray repellant canister having a cap and a removable trigger lock, the device having a housing with an alarm component forming the top of the housing and having an alarm microswitch, a battery component extending perpendicularly downward from a first end of the alarm component, a support bracket extending perpendicularly downward from a second end of the alarm component, and canister securing means.

The alarm microswitch may be set to an activated position or an inactivated position. When the alarm microswitch is in an activated position, the alarm is inactive when the trigger lock is attached, and activated when the trigger lock is removed.

According to another aspect, the invention is a method of use of a personal safety device as an alarm only, comprising the step of removing trigger lock from spray repellant canister.

According to another aspect, the invention is a method of use of a personal safety device as a spray repellant only, comprising the steps of setting alarm microswitch to deactivated position; removing trigger lock from spray repellant canister; and depressing spray nozzle.

According to another aspect, the invention is a method of use of a personal safety device as a spray repellant and alarm, comprising the steps of removing trigger lock from spray repellant; and depressing spray nozzle.

The support bracket may extend downwardly only to a position slightly below the bottom of the cap of the repellant spray canister, the device further comprising a pair of tabs disposed on opposing sides of the inside of the housing, one extending inwardly from the battery component, and the other extending inwardly from the support bracket, the tabs sized and positioned to be insertable into pin holes on the spray nozzle of the repellant spray canister to secure the housing to the canister.

The support bracket instead may extend downwardly past the cap along the body of the repellant spray canister, the device further comprising curved receptacle securing means attached to the inside of the bottom of the battery component and the bottom of the support bracket.

### DETAILED DESCRIPTION OF THE INVENTION

There is provided a personal safety device comprising a housing 2 attachable to a standard repellant spray canister.

The housing comprises an alarm component 4, a battery component 6, a support bracket 8, and canister securing means 12, 14, 18, 20. In a preferred embodiment, the alarm component forms the top of the housing, the battery component extends perpendicularly downward from one end of the alarm component, and the support bracket extends perpendicularly downward from the opposing end of the alarm component. The distance between the inner side of the battery component and the inner side of the support bracket is minimally larger than the diameter of a standard repellant spray canister.

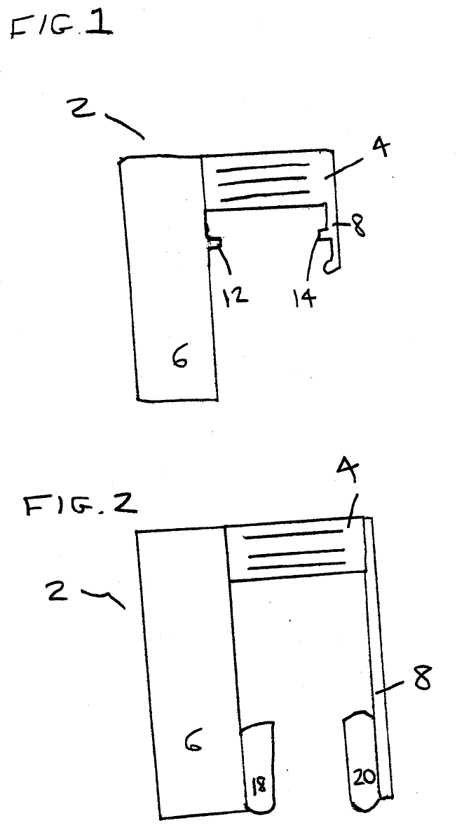

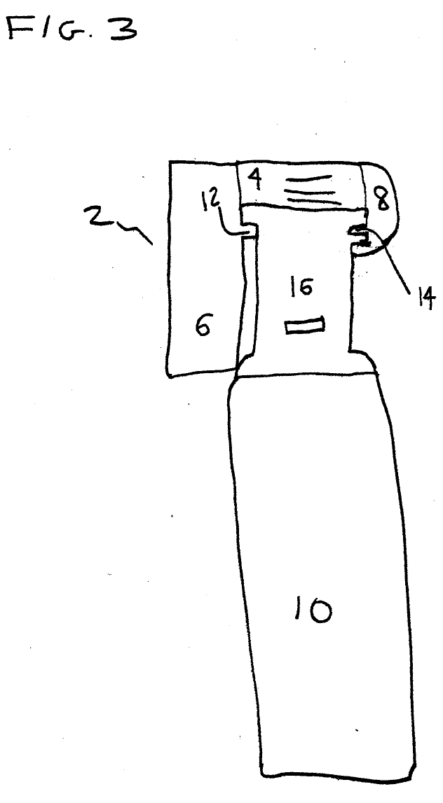

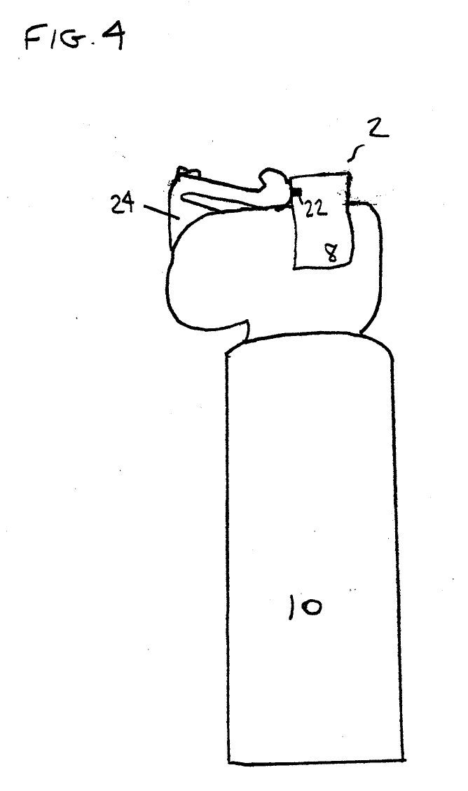

According to the embodiment shown in FIGS. 1, 3, and 4, the support bracket extends downwardly only to a position slightly below the bottom of the cap of the repellant spray canister. The securing means for this first embodiment comprise a pair of tabs 12, 14 disposed on opposing sides of the inside of the housing, one 12 extending inwardly from the battery component, and the other 14 extending inwardly from the support bracket. The tabs are sized and positioned to be insertable into pin holes on the spray nozzle 16 of the repellant spray canister 10 to secure the housing to the canister.

According to the embodiment shown in FIG. 2, the support bracket extends downwardly further along the bear repellant spray canister. In this embodiment, the securing means comprise curved receptacles 18, 20 attached to the inside of the bottom of the battery component and the bottom of the support bracket. The arc of the curved receptacle is selected to correspond to the curvature of the repellant spray canister such that the housing of this second embodiment may be reversibly snapped on to a repellant spray canister. This ease of removal and attachment permits reuse of the housing on a new bear spray canister once the contents of a previous canister are exhausted.

The housing of both embodiments may be attached to a repellant spray canister prior to sale, or may be sold as a separate item attachable to a spray repellant purchased separately.

The alarm component preferably has a capacity of at least 130 Decibels. The housing of the second embodiment may be used as an alarm independent of attachment to a repellant spray canister. According to one embodiment, the alarm component includes a microswitch 22 which is depressed into an off position by the pressure of an adjacent spray canister trigger lock 24. When the trigger lock is removed, the microswitch is released and activates the alarm of the device.

Preferably, the device of the present invention is used with a repellant spray canister having a trigger lock which prevents unintentional use of the repellant spray, and allows a user to select between use of only the repellant spray alone, only the alarm, or both. Use of alarm only is achieved by removing the trigger lock without activating the trigger. Use of alarm and repellant is achieved by removing the trigger lock and activating the repellant trigger. Use of spray repellant only is achieved by first deactivating the alarm microswitch before removing the trigger lock and spraying the repellant.

In use, the alarm component is positioned over the top of the repellant spray canister, and the battery component is adjacent one end of the alarm component and extends partially along one side of the repellant spray canister, with the support bracket extending along the opposite side.

By incorporating an alarm device into a repellant spray device, the present invention reduces the need for a person to carry more than one personal safety device, thereby reducing the size and weight carried by anyone requiring such devices. The device of the present invention minimally adds to the weight and size of the spray repellant, and is reusable.

The present invention is useful as a spray repellant deterrent against a bear, dog, human or other attacker, but is also useful simply as an alarm for use when a user is lost or when a user needs to draw attention to an event such as a crime or emergency situation.

It will be appreciated by those skilled in the art that other variations of the preferred embodiment may also be practiced without departing from the scope of the invention.

1. A reusable personal safety device for use with a spray repellant canister having a trigger lock, the device comprising a housing having an alarm component with first and second ends, a battery component, a support bracket, and canister securing means.

2. The personal safety device of claim 1, wherein the alarm component forms the top of the housing.

3. The personal safety device of claim 1, wherein the alarm component has an alarm capacity of at least 130 Decibels.

4. The personal safety device of claim 1, wherein the battery component extends perpendicularly downward from the first end of the alarm component.

5. The personal safety device of claim 1, wherein the support bracket extends perpendicularly downward from the second end of the alarm component.

6. The personal safety device of claim 1 wherein the distance between the inner side of the battery component and the inner side of the support bracket is minimally larger than the diameter of a prior art repellant spray canister.

7. A reusable personal safety device for use with a spray repellant canister having a cap and a removable trigger lock, the device comprising a housing having an alarm component forming the top of the housing and having an alarm microswitch, a battery component extending perpendicularly downward from a first end of the alarm component, a support bracket extending perpendicularly downward from a second end of the alarm component, and canister securing means.

8. The personal safety device of claim 7, wherein the alarm microswitch may be set to an activated position or a deactivated position.

9. The personal safety device of claim 8 having the alarm microswitch in an activated position, wherein the alarm is inactive when the trigger lock is attached, and activated when the trigger lock is removed.

10. A method of use of the personal safety device of claim 7 as an alarm only, comprising the step of removing the trigger lock from the spray repellant canister.

11. A method of use of the personal safety device of claim 7 as a spray repellant only, comprising the steps of:
a. setting the alarm microswitch to a deactivated position;
b. removing the trigger lock from the spray repellant canister; and
c. depressing the spray repellant canister nozzle.

12. A method of use of the personal safety device of claim 7 as a spray repellant and alarm, comprising the steps of:
a. removing the trigger lock from the spray repellant; and
b. depressing the spray repellant canister nozzle.

13. The personal safety device of claim 7 wherein the support bracket extends downwardly only to a position slightly below the bottom of the cap of the spray repellant canister, the device further comprising a pair of tabs disposed on opposing sides of the inside of the housing, one extending inwardly from the battery component, and the other extending inwardly from the support bracket, the tabs sized and positioned to be insertable into pin holes on the spray nozzle of the repellant spray canister to secure the housing to the canister.

14. The personal safety device of claim 7 wherein the support bracket extends downwardly past the cap along the body of the spray repellant canister, the device further comprising curved receptacle securing means attached to the inside of the bottom of the battery component and the bottom of the support bracket.

15. A reusable personal safety device for use with a spray repellant canister having a trigger lock, the device comprising a housing having an alarm component with first and second ends forming the top of the housing, a battery component extending perpendicularly downward from the first end of the alarm component, a support bracket extending perpendicularly downward from the second end of the alarm component, and canister securing means.
